(19) United States
(12) Patent Application Publication
(10) Pub. No.: US 2025/0081226 A1
(43) Pub. Date: Mar. 6, 2025

(54) A COMMUNICATION METHOD AND SYSTEM FOR RESOURCE ALLOCATION BASED ON QOS GRADES

(71) Applicant: ELTA SYSTEMS LTD., Ashdod (IL)

(72) Inventors: Itai BAR ZIV, Gedera (IL); Itay FUCHS, Nes Ziona (IL)

(21) Appl. No.: 18/262,587

(22) PCT Filed: Dec. 27, 2021
(86) PCT No.: PCT/IL2021/051540

§ 371 Date: Jul. 24, 2023

(30) Foreign Application Priority Data
Jan. 24, 2021 (IL) 280379

(51) Int. Cl. H04W 72/543; H04W 72/30

(52) U.S. Cl. CPC H04W 72/543; H04W 72/30

(57) ABSTRACT

A computerized hub node for generating a dynamic resource allocation map, informative of allocation of resources to a plurality of user nodes, in a wide bandwidth shared wireless link. The hub node includes a processor and memory circuitry (PMC) configured to perform calculation of a QOS threshold value based on user's QOS grades of transmitting user nodes, and transmission of the QOS threshold. Then, receiving resource allocation requests originating by corresponding requesting user nodes including identifying the user nodes. Then, updating the resource allocation map to indicate new allocated resources for the transmitting user nodes and the requesting user nodes, constituting, together, updated transmitting user nodes, while giving priority in allocation of resources to nodes having higher user node's QOS grade over nodes having lower user's QOS grad. Finally, transmitting the updated resource allocation map to the requesting user nodes through a hub transmission link, to thereby facilitate transmission of user payloads over the wide bandwidth shared wireless link, according to the updated resource allocation map.

### TECHNICAL FIELD

The presently disclosed subject matter relates to a communication method and system therefor.

### BACKGROUND

As is well known, ad hoc asynchronous access based networks, such as Push-to-talk (PTT), also known as press-to-transmit, is a method of having conversations or talking on half-duplex communication lines, including two-way radio, using a momentary button to switch from voice reception mode to transmit mode.

In many types of wireless networks, including satellite communication networks, but not limited thereto, data communication is possible through available bandwidth (“network resources”) which can be assigned to predefined users (“nodes”) associated with a portion of the network resources. These portions may or may not be utilized by their corresponding users, and may be reserved, i.e. not shared by other users. Division of the resources may be achieved by any known (or unknown) methods such as frequency division (e.g. FDM, FMDA), time division (TDM, TDMA), code division (CDMA) or any combination of the methods. For networks which are characterized by limited transmission periods (mobile nodes, mission-oriented nodes, etc.) or that are characterized by strict EEP (Electromagnetic Emission Policy), or that are based on legacy PTT networks which are defined by a shared transmission resource, there is a need to maximize the usage of such resources, specifically when the overall number of user nodes may require the total amount of spectrum/network resources which is higher than the maximum capacity of the network.

There is a need in the art to provide a novel communication method and system therefor that utilizes the advantages and restrictions of the PTT-like communication.

### GENERAL DESCRIPTION

In accordance with certain embodiments, there is provided a solution for ad hoc asynchronous access based networks that facilitates transmission of payload data (typically originating from a plurality of user nodes) over a wide bandwidth shared wireless link. The link has limited resources to allocate to the user nodes which in some operational scenarios may not be sufficient to meet the demand of all the user nodes which wish to transmit their payload simultaneously over the wireless link. Accordingly, there is provided a global hub node that defines a common criterion (e.g. a Quality of Service [QOS] threshold value) that is applicable to all user nodes which wish to transmit payload data, such that each user node can test whether it meets the criterion (e.g. its own user node's QOS value exceeds the threshold), in which case it is granted by the hub an access to transmit all or part of its queued payload data, or, if it does not meet the criterion, it is prohibited from transmission of the payload data.

According to one aspect of the presently disclosed subject matter there is provided a system comprising a computerized hub node for generating a dynamic resource allocation map, informative of allocation of resources to a plurality of user nodes, in a wide bandwidth shared wireless link, the hub node comprising a processor and memory circuitry (PMC) configured to perform repeatedly, including:
calculating a QOS threshold value based on user's QOS grades of transmitting user nodes, and transmitting the QOS threshold;
receiving at least one resource allocation request originating by corresponding at least one requesting user node including identifying the at least one user node;
updating the resource allocation map to indicate new allocated resources for the transmitting user nodes and the at least one requesting user nodes, constituting, together, updated transmitting user nodes, while giving priority in allocation of resources to nodes having higher user node's QOS grade over nodes having lower user's QOS grade; and
transmitting the updated resource allocation map to at least the requesting user nodes through a hub transmission link;
thereby facilitating transmission of user payloads over the wide bandwidth shared wireless link, according to the updated resource allocation map.

In addition to the above features, the system according to this aspect of the presently disclosed subject matter can comprise one or more of features (i) to (xi) listed below, in any desired combination or permutation which is technically feasible:
i. The computerized hub node, wherein the resource allocation request is generated by the requesting user nodes in response to meeting a QOS criterion that depends on the QOS threshold.
ii. The computerized hub node, wherein the updating the resource allocation map while giving priority in allocation to nodes having higher user node's QOS grade over nodes having lower user's QOS value, includes: in case there are not sufficient resources to meet the request of the at least one requesting user node, updating the resource allocation map to indicate allocated resources to the at least one requesting user node and reducing resources to at least one affected transmitting user node of the transmitting user nodes, based on at least its degraded user node's QOS grade compared to the user's QOS grades of at least one non affected transmitting node of the transmitting nodes.
iii. The computerized hub node, wherein the reducing includes reducing the resources, starting from the lowest user node's QOS grade of an affected transmitting node, and repeating, if required, for the next lowest user node's QOS grades of another affected transmitting node, until the requests of all requesting user nodes are met.
iv. The computerized hub node, wherein said reducing includes selectively reducing the allocated resources to an affected transmitting node by X % (X≤100).
v. The computerized hub node, wherein updating the resource allocation map while giving priority in allocation to nodes having higher user node's QOS grade over nodes having lower user's QOS grade, includes: in case the link is not fully occupied, allocate available resources to the requesting at least one node.
vi. The computerized hub node, wherein the wide bandwidth shared wireless link is an RF channel.
vii. The computerized hub node, wherein the QOS threshold value is based on the median function of the user's QOS grades.
viii. The computerized hub node, wherein, in case said shared wireless link is not fully occupied, setting the QOS threshold to a value that allows any requesting node to meet the QOS criterion.
ix. The computerized hub node, wherein the transmission of the QOS threshold is performed as a broadcast over a hub transmission link.
x. The computerized hub node, wherein the receiving of said at least one resource allocation request is performed through a narrow bandwidth access request link.
xi. The computerized hub node, wherein the transmission of user payload data complies with an IP protocol, and wherein the payload data are IP packets.

According to another aspect of the presently disclosed subject matter there is provided a computerized user node for transmission of user generated payloads over a wide bandwidth shared wireless link, the user node comprising a processor and memory circuitry (PMC) configured to perform repeatedly, including:
obtaining, from at least one host application associated with the user node, a plurality of payload data associated control that includes Quality of Service (QOS) value and calculating a user node's QOS grade according to at least the QOS values;
receiving from a hub node a QOS threshold value;
in case of meeting a QOS criterion, transmitting, through a narrow bandwidth access request link, a resource allocation request, the QOS criterion that depends on said QOS threshold;
   responsive to the request, receive from the hub node a dynamic resource allocation map, informative of allocation of resources in a wide bandwidth shared wireless link to a plurality of user nodes;
   transmitting, through the resource allocated to the user node in the map, selected payload data of the plurality of payload data along with the user's QOS value, until a transmit stop criterion is met;
   the payload data being selected according to a payload data transmission criterion that depends on at least their QOS value.

In addition to the above features, the system according to this aspect of the presently disclosed subject matter can comprise one or more of features (a) to (j) listed below, in any desired combination or permutation which is technically feasible:
(a) The computerized user node, wherein the wide bandwidth shared wireless link is an RF channel.
(b) The computerized user node, wherein the calculating a user node's QOS grade according to the QOS values is based on weighted average of the QOS values.
(c) The computerized user node, wherein the plurality of payload data are accumulated in at least one queue according to their QOS value, and wherein the weighted average takes into account the queue's length.
(d) The computerized user node, the threshold being received from the hub node over a hub transmission link.
(e) The computerized user node, wherein the dynamic resource allocation map is received from the hub node over a transmission link.
(f) The computerized user node, wherein the transmit stop criterion is met in case at least one of the following conditions is met: (i) all obtained payload data are transmitted, (ii) a halt command is received from the hub or (iii) an updated dynamic resource allocation map is received where no resources are allocated to the user node.
(g) The computerized user node, wherein the payload data transmission criterion that depends on at least their QOS value includes applying a QOS queuing mechanism that includes CBWFQ—a Class Based Weighted Fair Queuing technique.
(h) The computer user node, further comprising: in case data informative of the resource allocation map is received from the hub while transmitting, wherein the map includes updated resource allocating, update the selected payload data to fit the newly allocated resource.
(i) The computerized user node, wherein the transmission of user payload data complies with an IP protocol, and wherein the payload data are IP packets.
(j) The computerized user node, wherein the payload data are generated or received by at least one host application associated with the user node.

According to a further aspect of the presently disclosed subject matter there is provided a method for generating a dynamic resource allocation map, informative of allocation of resources to a plurality of user nodes in a wide bandwidth shared wireless link; the method comprising performing repeatedly by a processor and memory circuitry (PMC):
calculating a QOS threshold value based on a user's QOS grades of transmitting user nodes, and broadcasting the QOS threshold;
receiving at least one resource allocation request originating by corresponding at least one requesting user node including identifying the at least one user node;
updating the resource allocation map to indicate new allocated resources for the transmitting user nodes and the at least one requesting user node, constituting together updated transmitting user nodes while giving priority in allocation of resources to nodes having higher user node's QOS grade, over nodes having lower user's QOS grade; and
transmitting the updated resource allocation map to at least the requesting user nodes through a hub transmission link;
thereby facilitating transmission of user generated payloads over the wide bandwidth shared wireless link, according to the updated resource allocation map.

In addition to the above features, the method, according this aspect of the presently disclosed subject matter, can comprise one or more of the specified features (i) to (xi) outlined above, in any desired combination or permutation which is technically feasible.

According to yet a further aspect of the presently disclosed subject matter there is provided a method for transmission of user payloads over a wide bandwidth shared wireless link, the method comprising performing repeatedly, by a processor and memory circuitry (PMC):
obtaining from at least one host application associated with a user node, a plurality of payload data associated control that includes Quality of Service (QOS) value and calculating a user node's QOS grade according to at least the QOS values; receiving from a hub node a QOS threshold value;
in case of meeting a QOS criterion, transmitting, through a narrow bandwidth access request link, a resource allocation request, the QOS criterion that depends on the QOS threshold;
   receiving from the hub node, responsive to the request, a dynamic resource allocation map, informative of allocation of resources in a wide bandwidth shared wireless link to a plurality of user nodes; and
   transmitting, through the resource allocated to the user node in the map, selected payload data of the plurality of payload data along with the user's QOS value, until a transmit stop criterion is met;
   the payload data are selected according to a payload data transmission criterion that depends on at least their QOS value.

In addition to the above features, the method, according this aspect of the presently disclosed subject matter, can comprise one or more of the specified features (a) to (j) outlined above, in any desired combination or permutation which is technically feasible.

There is yet further presented a non-transitory computer readable storage medium tangibly embodying a program of instructions that, when executed by a computer, cause the computer to perform a method of generating a dynamic resource allocation map, informative of allocation of resources to a plurality of user nodes, in a wide bandwidth shared wireless link, in accordance with the method for generating a dynamic resource allocation map discussed above.

There is yet further presented a non-transitory computer readable storage medium tangibly embodying a program of instructions that, when executed by a computer, cause the computer to perform a method of transmission of user generated payloads over the wide bandwidth shared wireless link, in accordance with the method for transmission of user payloads over a wide bandwidth shared wireless link discussed above.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates a schematic illustration of a communication system in accordance with certain embodiments of the presently disclosed subject matter;

FIG. 2A illustrates a functional block diagram of a hub node system in accordance with certain embodiments of the presently disclosed subject matter;

FIG. 2B illustrates a functional block diagram of a user node system in accordance with certain embodiments of the presently disclosed subject matter;

FIG. 3 illustrates a generalized flow-chart of a sequence of operations performed by a communication system, in accordance with certain embodiments of the presently disclosed subject matter;

FIG. 4 illustrates a generalized flow-chart of a sequence of operations performed by a hub node in a communication system, in accordance with certain embodiments of the presently disclosed subject matter;

FIG. 5 illustrates a generalized flow-chart of a sequence of operations performed by a user node in a communication system, in accordance with certain embodiments of the presently disclosed subject matter;

FIG. 6 illustrates a payload data packet structure, in accordance with certain embodiments of the presently disclosed subject matter; and

FIG. 7 illustrates an exemplary resource allocation map in accordance with certain embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

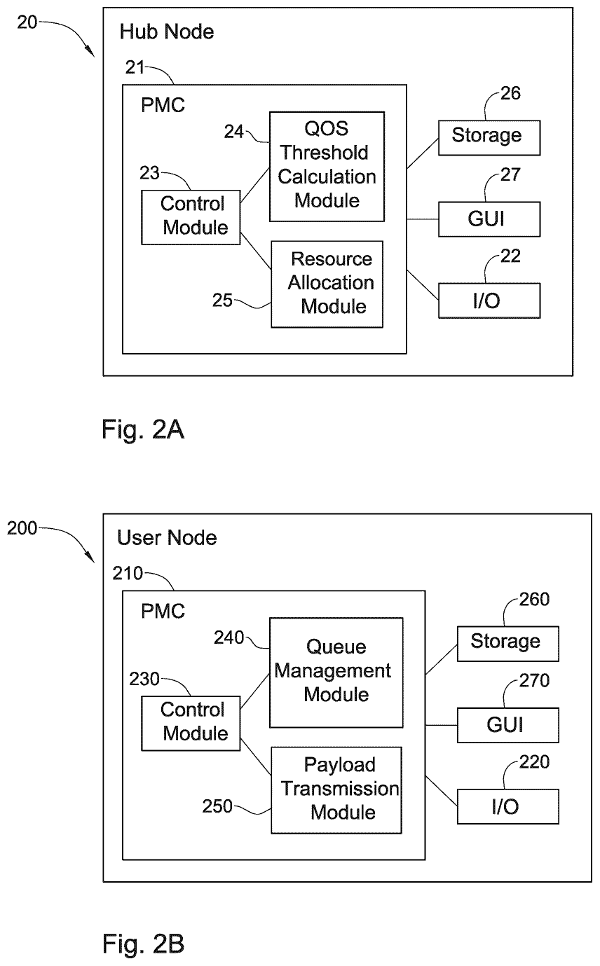

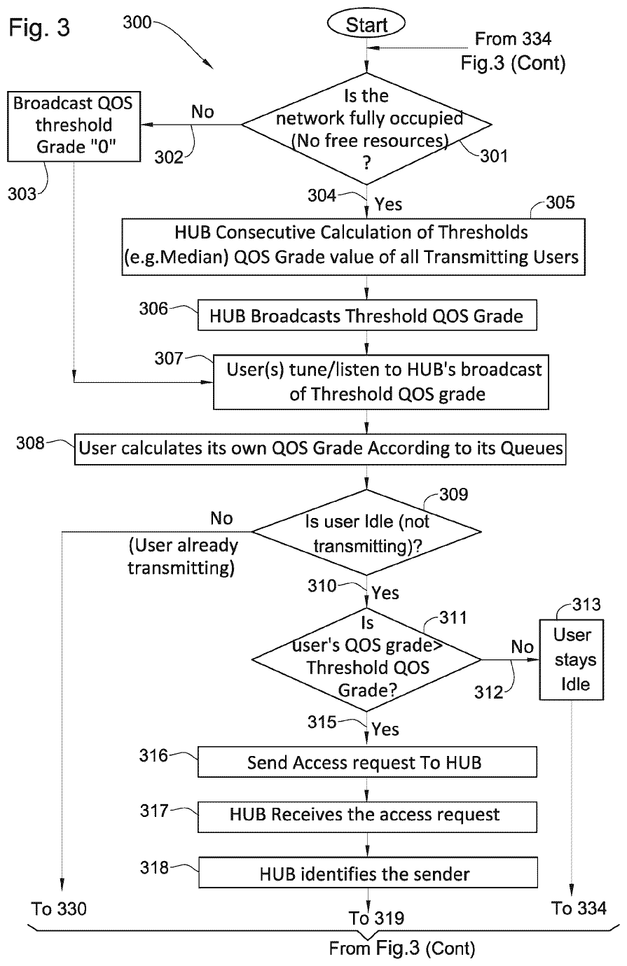

Unless specifically stated otherwise, as apparent from the following discussions, it is appreciated that throughout the specification discussions utilizing terms such as “processing”, “computing”, “calculating”, “updating”, “performing” or the like, refer to the action(s) and/or process(es) of a computer that manipulate and/or transform data into other data, said data represented as physical, such as electronic, quantities and/or said data representing the physical objects. The term “computer” (including processor and memory circuitry (PMC)) should be expansively construed to cover any kind of hardware-based electronic device with data processing capabilities including, by way of non-limiting example, those in FIGS. 2A and 2B disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes, or by a general-purpose computer specially configured for the desired purpose by a computer program stored in a non-transitory computer-readable storage medium.

The term node used in this patent specification should be expansively construed to cover using a PMC (a processor and memory circuitry), as exemplified in FIG. 2 and throughout the specification.

Embodiments of the presently disclosed subject matter are not described with reference to any particular programming language. It will be appreciated that a variety of programming languages may be used to implement the teachings of the presently disclosed subject matter as described herein.

Note that throughout the description, whenever reference is made to a given term that represents data or information, it may be construed, if applicable, to embrace also data informative of the term, including but not limited to different representations and formats thereof, derivatives thereof, and so forth. For instance, when reference is made to the term “analog”, it may embrace, if applicable, digital representation thereof, or by another non-limiting example, be coded from a term, and others. For instance, throughout the description reference is made to the term “resource allocation map”. This term may embrace data informative of a “resource allocation map”, e.g. various formats that represent a “resource allocation map”, or any data structure that is representative of a resource allocation map, and so forth.

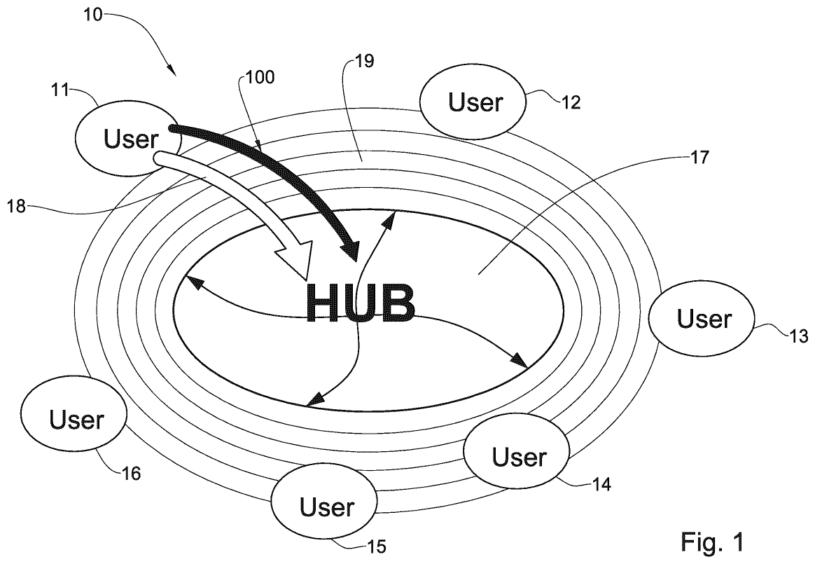

Bearing this in mind, attention is drawn to FIG. 1, illustrating schematically a communication system 10 in accordance with certain embodiments of the presently disclosed subject matter. Thus, a plurality of computerized user nodes (of which user nodes 11-16 are shown) are capable of communicating with computerized hub node 17, for transmission of payload data and associated control that includes QOS value (see e.g. 18 transmitted from user node 11) over a wide bandwidth shared wireless link, e.g. an RF channel (not shown in FIG. 1). Note that the invention is neither bound by the RF type, nor by a single channel. In accordance with certain embodiments, the payload data may be transmitted to the RF channel in a known per se manner, e.g. utilizing an RF modem (fitted e.g. in I/O module 22—which is a schematic representation of the Input/Output module(s) that are used by the user node).

Although not shown in FIG. 1, note that each user node (utilizing a processor and memory circuitry (PMC), as depicted in FIG. 2) may be configured to transmit the payload data through a resource that is dynamically allocated thereto (e.g. in the RF channel) by the computerized hub node. The latter utilizes a processor and memory circuitry (PMC), as described with reference to FIG. 2. The hub may allocate the resource to user nodes based inter alia on their respective user's QOS values (calculated in accordance with various embodiments, e.g. based on at least the QOS values ([of the control portion] associated with the payload data of the user node, all as will be explained in greater detail below).

Accordingly, considering that, typically, the bandwidth of the shared wireless link (e.g. RF channel) is not sufficient to accommodate all the resources that are required by the various user nodes to transmit all their (queued) payload data, the hub node may be configured to dynamically prioritize transmission of payload data that originate from requesting user nodes based on the users' QOS values, all as will be explained in greater detail below.

The hub node may periodically notify the user nodes on their respective allocated resources by transmitting (e.g. by broadcasting, possibly through hub transmission link—see 19 in FIG. 1-) an updated resource allocation map informative of allocation of resources in a wide bandwidth shared wireless link, to the plurality of user nodes that request to transmit their payload. The updated resource allocation map may affect the resources allocated to already transmitting node (e.g. reduce by X % and in some cases to 0), all as will be explained in greater detail below). As readily arises from various embodiments of the present invention, the resource allocation map is dynamically updated and broadcasted to the users' nodes. The frequency of the update and the broadcast are not necessarily related. Note that, whereas, for simplicity, the description herein refers to “broadcasting” (e.g. through dedicated hub transmission channel/link), it should be regarded as a non-limiting example of “transmission”. Thus, another form of transmission may be, for instance to one or more user nodes, e.g. a unicast (point to point) transmission which is sent to each and every user node. The hub transmission link may be a dedicated link, or otherwise an integrated/multiplexed link.

Each user node which aims at transmitting payload data may send through e.g. a dedicated narrow bandwidth access request link (see 100—a request originating form user node 11), a resource allocation request. Note that in accordance with certain embodiments, access transmission is not considered as payload transmission, but a “control” asset of the network, therefore, this access channel does not come for free. The access channel may be “slim” in terms of utilization of resources in order to improve or maximize the allocated resources in the wireless link which can be used for payload only. Alternative non-limiting examples of implementing the access channel may be found in https://en.wikipedia.org/wiki/Channel_access_method.

Note that the attributes of the access channel may be short/slim/asynchronous/ad hoc, and, in accordance with other embodiments, the access channel may be implemented not necessarily as a dedicated physical channel, as will be explained in greater detail below.

Reverting to the access request, this may be initiated in response to meeting a QOS criterion that may depend on said QOS threshold: (by this non-limiting example, the criterion may prescribe that the user's node QOS grade exceeds a QOS threshold value calculated (and transmitted) by the hub, all as will be explained in greater detail below. Note that the invention is not bound by the specified example of the QOS criterion that depends on said QOS threshold.

Note that a request is typically sent from the user node after the latter has verified that it met the QOS criterion. Note that throughout the description, in accordance with certain embodiments, the broadcasting of the threshold and the map may be done separately (not in the same timing), whereas, in accordance with other embodiments, this may be done simultaneously, all depending upon the particular application and physical constrains (e.g. propagation time delay for satellite communication).

The hub node, in turn, complies with the request (considering that the request has been sent only after the user node has confirmed that the QOS criterion has been met), and allocates a given resource to the user node. The allocated resource does not necessarily fit the desired resources, such that the user node needs to send all its accumulated (queued) payload data, and, in the latter case, the user node may transmit payload data based on a criterion that depends on their associated QOS value, e.g. in descending order, where the payload with the highest QOS value is transmitted first, and so forth. In accordance with certain embodiments, a different transmission paradigm may be opted by the user node, e.g. the commercially QOS queuing mechanism such as CBWFQ—Classed Based Weighted Fair Queuing. The invention is not bound by the specified QOS prioritization transmission paradigms.

The payload data that were not transmitted in the current resource allocation may be transmitted in future allocated resources (unless other circumstances are encountered, e.g. the payload data is discarded in compliance with a timeout policy applicable at the user's node).

It is accordingly appreciated that in accordance with certain embodiments, the resource allocation to users is dynamic and may depend upon at least e.g. (i) the user's QOS values of the payload data of user nodes that request to transmit, and/or (ii) the available resources in the wireless link vs. the resources that are required by the transmitting nodes and those that request to transmit, and/or (iii) a QOS threshold calculated by the hub node and which is informative of a function (e.g. median) of the transmitting user node's QOS grade.

Note that in accordance with certain embodiments, when payload data is transmitted, and consequently the self-calculated user node's QOS grade drops below the threshold, the user node may continue and transmit payload data until e.g. another map with different resource allocation is received. In accordance with certain other embodiments, in case of dropping below the threshold, the user node halts transmission (note that the terms user node's QOS grade and user node's QOS value, may be used interchangeably).

It is noteworthy that the payload data and the associated control portion (for transmission) of each user node may be generated or received by one or more host applications associated with the user node, and may be queued for transmission at a lower communication layer e.g. the data link layer. Note that the user node may reside in, or be associated with, a stationary or moving platform (say, an airborne platform such as a UAV).

Note also that in accordance with various embodiments, the user node (which may be referred to herein interchangeably as “host node”) may be a part of a network of nodes. In such a network only one or more of the nodes is capable of transmitting payload data through the wireless link. Thus, a user node in the network is capable of receiving payload data from a host application of other nodes in the network (the host application being thus associated with the user node), for transmitting through the wireless link in accordance with the teachings of the various embodiments of the presently disclosed subject matter. In accordance with certain embodiments, the specified node may also transmit through the network its own originated payload data (originated by a host application of the user node). Other architecture host applications associated with the user node are also applicable, all depending upon the particular application.

The so queued payload data will be transmitted as described herein, and those that are delayed may remain queued until they may be transmitted at a later stage (through a resource allocated to the user in a future broadcasted resource allocation map), or e.g. discarded (e.g. in compliance with a time-out policy that is utilized by the user node). It is thus appreciated that the payload transmission and prioritizing paradigm (according to available resources and users' QOS values) is kept transparent to the host application(s) in the sense that the latter may send the host originated payload to the lower layer (e.g. a data link layer through the IP layer), irrespective of the queuing and transmission (to the physical layer) of the payload data by the lower (e.g. data link) communication layers, constituting thus yet another advantage in the proposed communication paradigm. Note that payload data in the form of IP packets that comply with an IP protocol, is only a non-binding example.

Attention is now drawn to FIG. 2A illustrating a functional block diagram of a hub node system 20 in accordance with certain embodiments of the presently disclosed subject matter. The illustrated system 20 can be a computer-based system capable of managing and prioritizing (resource allocation) for transmission of payloads from a plurality of user nodes over a wide band shared wireless communication link, all as will be described in further detail below.

System 20 includes a processor and memory circuitry (PMC) 21 operatively coupled to a hardware-based I/O interface 22, which, according to certain embodiments, facilitates broadcasting of a resource allocation map (through e.g. a dedicated hub broadcast transmission link) and receiving resource allocation requests from user nodes (through e.g. a narrow bandwidth access request link). PMC 21 is configured to provide all processing necessary for operating the system 20 as further detailed below, and comprises a processor (not shown separately) and a memory (not shown separately). The processor of PMC 21 can be configured to execute several functional modules in accordance with computer-readable instructions implemented on a non-transitory computer-readable memory comprised in the PMC. Such functional modules are referred to hereinafter as comprised in the PMC.

According to certain embodiments of the presently disclosed subject matter, non-limiting functional modules comprised in PMC 21 can include operatively coupled therebetween control module 23, QOS threshold calculation module 24, and resource allocation map module 25. System 20 may further include storage module 26 and GUI module 27.

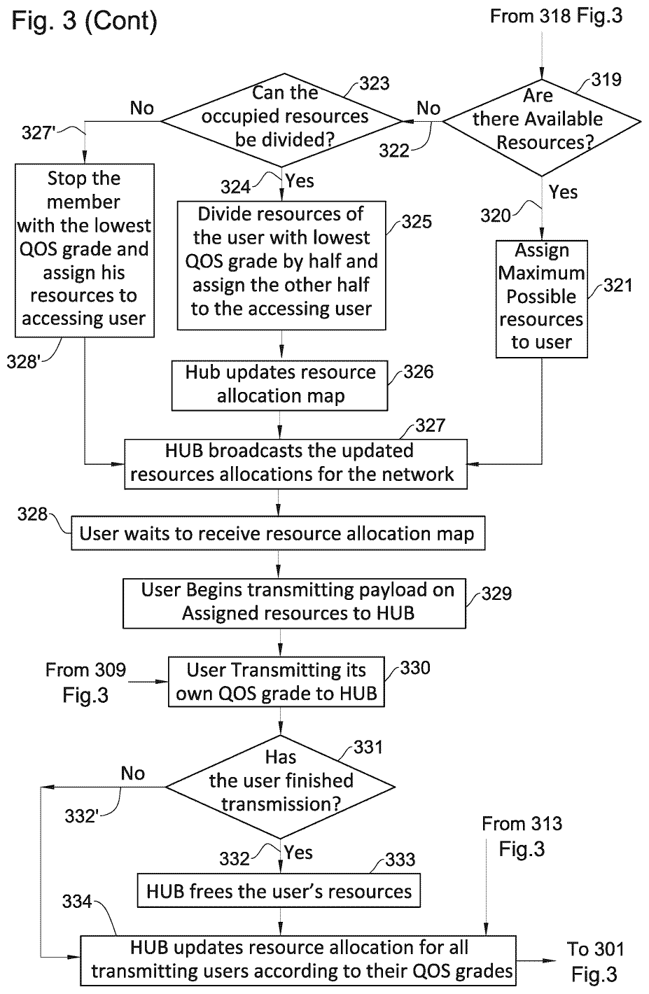

Operation of system 20, PMC 21 and the functional modules therein will be further detailed with reference to FIG. 3 and onwards below.

Note that the invention is not bound by the specified modules and the various sequence operations described with reference to various embodiments herein may be implemented by modified or different modules than those described with reference to FIG. 2A.

Attention is now drawn to FIG. 2B illustrating a functional block diagram of a user node system 200 in accordance with certain embodiments of the presently disclosed subject matter. The illustrated system 200 can be a computer-based system capable of requesting access to and transmission of payload data over allocated resources (in response to the access request) in a wide band shared wireless communication link. The resources are allocated to the user node in response to the requested access, all as will be described in further detail below.

System 200 includes a processor and memory circuitry (PMC) 210 operatively coupled to a hardware-based I/O interface 220, which, according to certain embodiments, facilitates transmission of resource allocation requests from user nodes (through e.g. a narrow bandwidth access request link) to the hub node, and receiving, in response thereto, (possibly after certain delay), a resource allocation map (through e.g. a dedicated hub broadcast transmission link). The PMC 210 is configured to provide all processing necessary for operating the system 200 as further detailed below, and comprises a processor (not shown separately) and a memory (not shown separately). The processor of PMC 210 can be configured to execute several functional modules in accordance with computer-readable instructions implemented on a non-transitory computer-readable memory comprised in the PMC. Such functional modules are referred to hereinafter as comprised in the PMC.

According to certain embodiments of the presently disclosed subject matter, non-limiting functional modules comprised in PMC 210 can include operatively coupled therebetween control module 230, queue management module 240, and payload transmission module 250 (utilizing e.g. known per se communication layers, in accordance with, say the OSI layer). System 200 may further include storage module 260 and GUI module 270.

Operation of system 200, PMC 220 and the functional modules therein will be further detailed with reference to FIG. 3 and onwards below.

Note that the invention is not bound by the specified modules, and the various sequence operations described with reference to various embodiments herein may be implemented by modified or different modules than those described with reference to FIG. 2B.

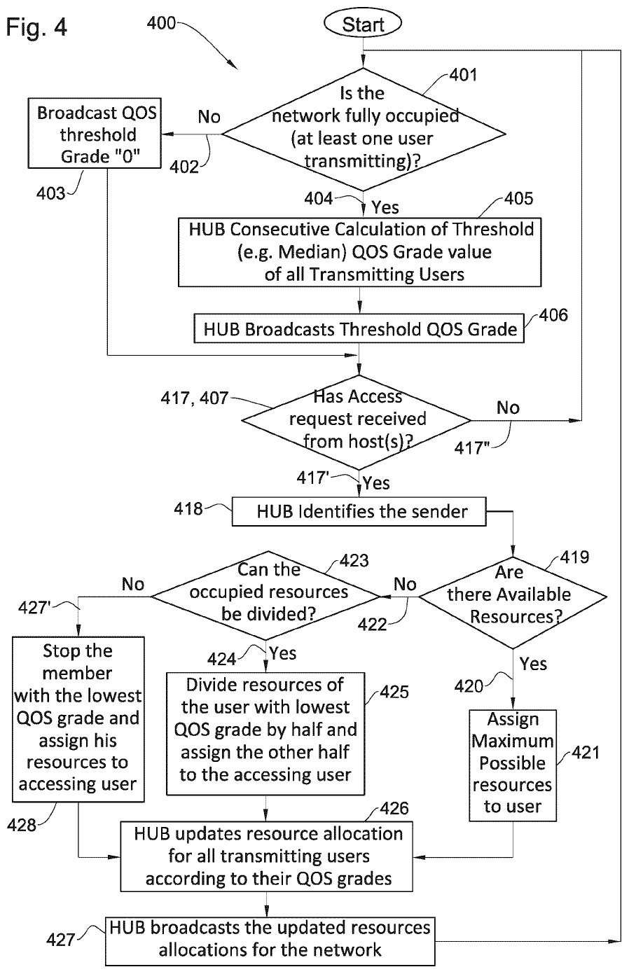

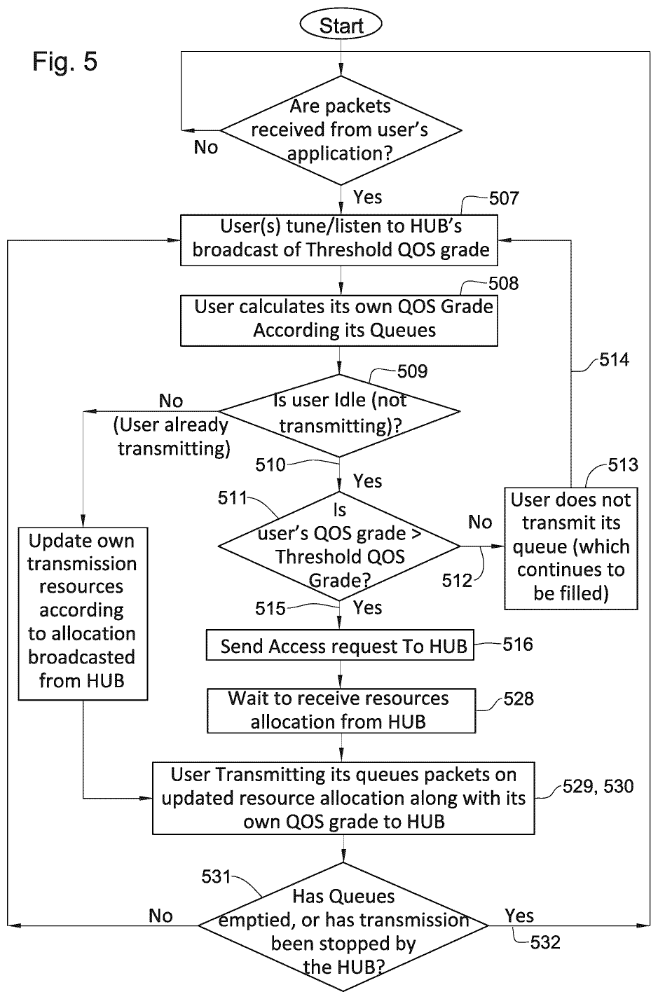

Attention is now drawn to FIG. 3 illustrating a generalized flow-chart of a sequence of operations performed by a communication system, in accordance with certain embodiments of the presently disclosed subject matter. The sequence of operations 300 of FIG. 3 combines those performed by the user node and the hub node. Note that the distinct sequence of operations for the user node and the hub node will be described with reference to FIGS. 4 and 5, respectively. Note that the sequence of operations may be performed on hub node system 20 and user node system 200 and executed by the respective PMC 21 and 210 that run the executable modules further disclosed herein. Note also that in accordance with certain embodiments, the sequence of operations performed with reference to the user node (see, e.g. FIG. 5), may be performed at the data link layer or associated therewith (while controlling transmission of the payload data (utilizing resources allocated by the hub node) through the physical layer.

Thus, in step 301 the hub node inquires if the network is not fully occupied (at least one user transmits), and in case of “No” 302 the hub node system (in short, hub node) may set the QOS threshold value to “0” (thus “inviting” user nodes to transmit payload, as there are available resources). Data informative of the latter may be broadcasted 303, e.g. over hub transmission link and is received by all user nodes which listen to the link (e.g. through I/O interface 210).

Otherwise, in case the network is fully occupied (i.e. “Yes” in 304), the QOS threshold value may be calculated 305 based on extracted user's QOS values [(e.g. median] of transmitting user nodes. Data informative of the so calculated QOS threshold value may be broadcasted (e.g. through the I/O interface 210) over the hub transmission link.

Note that the specified computational stages 301-306 in the communication system sequence of operations are mirrored in corresponding stages 401-406 of FIG. 4 illustrating a generalized flow-chart of a sequence of operations performed by the hub node. Note that the specified stages may be implemented in QOS threshold calculation module 24 executed by the PMC 21 (see FIG. 2A).

Note that the specified steps 301 to 306 (or 401-406) may be executed in module 24 of FIG. 2A under the supervision of control module 23 and the data may be transmitted through I/O 22.

Note that the specified steps exemplify, in a non-limiting manner, the step of calculating a QOS threshold value based on extracted user's QOS values, and broadcasting the threshold.

Independently, user nodes (e.g. 11—see FIG. 1) may accumulate (e.g. in queue stored in storage 260) payload data (e.g. packets complying with an IP protocol that are forwarded to the data-link layer from the IP layer) for transmission. The payload data may be generated by one or more known per se host applications associated with the user node. The payload data is designated for transmission in the wide bandwidth shared wireless link (e.g. an RF channel) in accordance with the teachings of various embodiments of the presently disclosed subject matter. To this end, the user node listens 307 to the broadcast link to receive the so broadcasted QOS threshold value. Note that, whereas, for convenience of explanation, the term queue is used, the invention is not bound by any data structure for storing the payload data for transmission.

Note also that whenever a term is used in the specification in its singular form, it may encompass, in certain embodiments, also its plural form. For example, the term “queue” may refer to more than one queue.

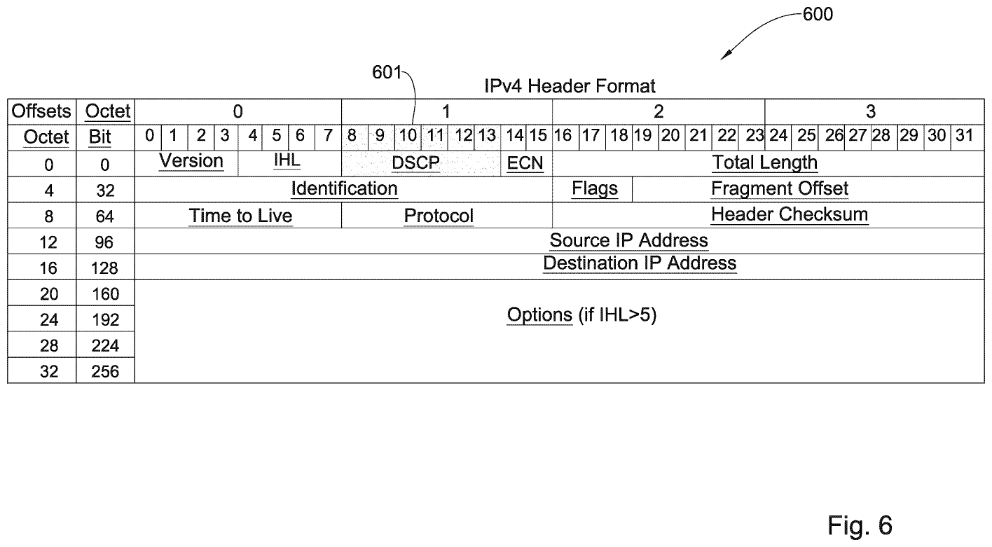

Moving on with FIG. 3, in accordance with various embodiments of the invention, a user node that aims at transmitting the queued payload data may calculate a user node's QOS grade 308 based on a criterion that depends on the control portion of the payloads, utilizing at least the QOS value (see further discussion with reference to FIG. 6 below).

For a better understanding, attention is drawn to FIG. 6, illustrating a payload data packet structure 600, in accordance with certain embodiments of the presently disclosed subject matter. As shown the TP packet structure 600 includes a payload portion and the associated control portion that includes plurality of known per se fields. From among the fields, the DSCP 601 (standing for Differentiated Services Code Point) is informative of the QOS value (which may be referred to by this example also as TOS—Type of Service). By this example, the user QOS grade will be calculated based on only the distinct QOS values (the DSCP field 601) as well as the queue lengths. Note that the invention is not bound by these parameters only, and, accordingly, other parameters may be used (instead of, or in addition to, the QOS value), say the specified queue length, in determining the user node's QOS grade. Thus, this particular example of the DSCP field (informative of the distinct QOS value) may include the following values:

TABLE 1

| TOS | Weight |
|---|---|
| 0- Best Effort | 4% |
| 1- Priority | 6% |
| 2- Immediate | 8% |
| 3- Flash | 10% |
| 4- Flash Override | 12% |
| 5- Critical | 15% |
| 6- Internetwork Control | 20% |
| 7- Network Control | 25% |
| | Sum = 100% |

where the “Best Effort” stands for the lowest QOS value, and “Network trol” stands for the highest QOS value. The values and the weight in Table 1 above, are, course, not binding, and are provided by way of example only.

For a better understanding, consider the following example. Assume that for each user node manages a separate queue for each QOS value (i.e. up to 8 queues per node). Assume also that the user node's QOS grade of the user node is calculated as a weighted average of the distinct QOS values (extracted from the DSCP field) of the payload data. And, more specifically, the user node's QOS grade complies with the following equation:

$$Grade = {\sum }_{i = 1}^{n} ( {length}_{Qi} \cdot {weight}_{{TOS}_{i}} )$$

where length_{Qi} is the number of total IP packets in queueᵢ, weight_{TOSi} is TOS value of queueᵢ packets, and n is the number of queues.

Consider the following example:
For a given user node (say, 11, see FIG. 1), the “Best Effort” queue (TOS=0) includes 50 packets. In the “Priority” queue (TOS=1) there are 20 packets and in the “Network Control” (TOS=7) queue there are 5 packets. The other queues (TOS=2 to TOS=6) are empty.
Accordingly, the user node's QOS grade will be: 0.04×50+0.06×20+0+0+0+0+0+0.25×5=4.45.
Note that the QOS value in the DSCP field may be set by the host application that originates (or is received) from the packet.

The criterion of weighted average of the extracted QOS values is, of course, merely an example, and is by no means binding.

It is accordingly appreciated that the user node has received the so calculated QOS threshold value and has calculated its own user node's QOS value (308).

Note that the invention is neither bound e.g. by utilizing only the QOS values and queues to calculate the user node's QOS grade, nor by the use of all QOS values of the payload (IP packets) and obviously not by the specified equation discussed above.

Reverting now to FIG. 3, and assuming that the user node is not transmitting (309, 310) then an inquiry is made 311 as to whether the self user node's QOS grade exceeds (exceeds in the context of various embodiments of the present invention may be construed as “>” possibly by a given margin, or >, depending upon the particular application), the QOS threshold value. As may be recalled in cases where the network is not fully occupied, the QOS threshold value may be set by the hub node to “0” (see stage 303), thereby assuring that the specified condition 311 is met. If, however, the network is fully occupied, and the calculated QOS threshold value >0, then the specified condition test 311 may be either met, or not met. In case of “No” 312, the user node may stay idle (313), and keeps receiving and queueing new payload data from its associated host applications (if any), and re-calculates its user node's QOS grade in the manner specified, and listens to newly broadcasted QOS threshold value (314).

Reverting to inquiry 311, in case that the specified condition (being an example of the specified QOS criterion) is met 315, (by this example self user node's QOS grade exceeds the QOS threshold value), the user node may send data informative of the resource allocation request through e.g. a dedicated narrow bandwidth access request link (see 100 in FIG. 1). As discussed above, there may be alternatives to the specified dedicated narrow bandwidth access request channel. Note that the specified QOS criterion is not bound by only testing to the QOS grade and/or threshold, and, accordingly, other parameters may be used when checking the QOS criterion.

As will be explained in greater detail below, in accordance with certain embodiments, considering that a request to allocated resources was issued only after the condition was tested and met (315), the hub node that received the request (316) must comply with the request and allocate resources for transmission to the requesting node (and, in accordance with certain embodiments, if there is more than one request, allocate such to all of them).

Note that the specified stages performed by the user node (307-316) are also illustrated, corresponding to stages (507-516) of the sequence of operations performed by the user node, as depicted in FIG. 5.

Note that the specified steps 307 to 316 (or 507-516) may be executed in module 240 of FIG. 2B under the supervision of control module 230 and the data may be transmitted through I/O 220.

Reverting now to FIG. 3, attention is drawn to stage 317 elaborating the processing, at the hub node end, of the request from the user node to allocate resources for transmitting the payload (or multiple requests received from respective multiple user nodes). After receiving the resource allocation request, the hub may check the identity of the requesting user node 318.

In accordance with certain embodiments, the identification of the user node can be performed by transmitting a unique RF pattern at a dedicated physical layer (associated with the data link layer) of the access channel which is informative of the user node's identity and can be identified by the HUB node. By yet another non-limiting example, a short, known data payload, identifying, uniquely, each user node, may be transmitted through the access channel. The invention is not bound by these examples. Other known per se techniques may be used, for instance dedicated time slots allocated to a given known number of nodes, or others which do not require knowledge in advance (e.g. obviating the need of pre-registration) and so forth, all as known per se.

Moving on with FIG. 3, in accordance with certain embodiments, considering that a request was initiated by the user node only after complying with the QOS criterion, the hub node must comply and allocate a resource or resources (in case there is more than one requesting user node). The allocated resource(s) do not necessarily fit the requested resources, such that the user node(s) needs to send all its accumulated (queued) payload data, and, in the latter case, the user node may transmit payload data based on a criterion that depends on their associated QOS value, all as will be explained in greater detail below.

Thus, in accordance with certain embodiments, the resource allocation process at the hub node end includes:

In stage 319 an inquiry may be made as to whether there are available resources (namely the wireless link is not fully occupied). In case of “Yes” (320), the available resources may be allocated 321 to the requesting nodes. Note that available resources may refer to all non-used resources, or portions thereof, leaving resources for designated usage such as (non-limiting) (i) e.g. for implementing a slim, ad-hoc access request channel, or e.g. (ii) in case a user node can transmit only in a given frequency, whereas the network can allocate multiple frequencies, then obviously the frequencies that are not supported by the user node cannot be allocated thereto. The same holds true for “fully occupied”, namely not all the resources are allocated, mutatis mutandis.

Note that in the case of more than one requesting user, the available resources may be divided between the requesting user nodes, e.g. evenly distributed between the requesting user node, or in accordance with another example, the resources are distributed. Note that these are only non-limiting examples. Note that the resources that were allocated may or may not fit the resources that the user node(s) require for transmitting their entire queued payload data. Or, in other words, the volume of the resources required by the user node(s) to transmit all their queued payload data may exceed the total allocated available resources.

Note also that in accordance with certain embodiments, the requesting users designate data informative of a request to allocate resources, as well as their identity, but do not designate the volume of the requested resources for allocation.

Bearing this in mind, the newly allocated resources to the requesting users, as well as those of the transmitting users, are updated in a resource allocation map 326 being informative of the resources allocated to the already transmitting nodes (which, by this embodiment, are non-affected, because the requesting user nodes have been assigned with only the non-used resources) and the available resources that were allocated to the requesting user(s). Note that the term “map” should be construed as a logical map, and is not bound by any particular data structure. The previous map and the updated map may be stored in storage 26. The updated resource allocation map is then broadcast (327) over the hub transmission link.

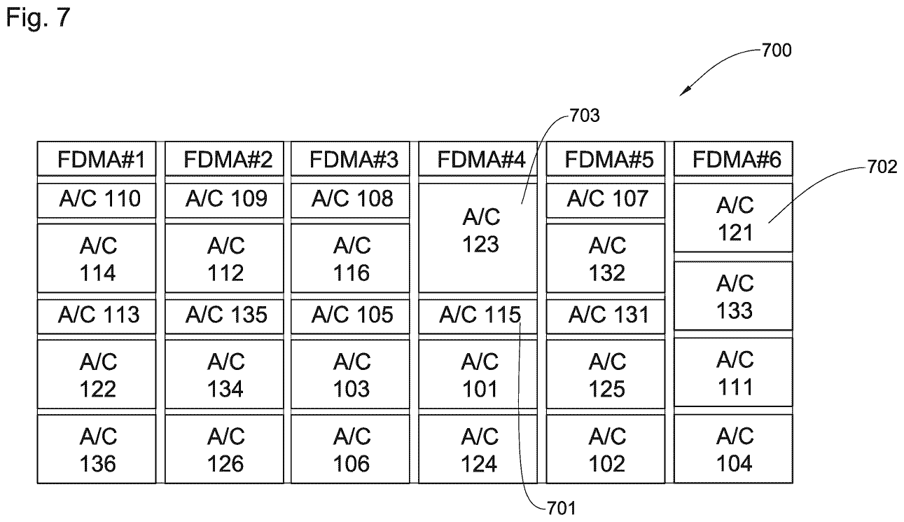

Before moving on with FIG. 3, attention is drawn to FIG. 7, illustrating an exemplary resource allocation map in accordance with certain embodiments of the presently disclosed subject matter. Note that the data structure depicted in FIG. 7 is a table, but the invention is obviously not bound by this example. Thus, resource allocation table 700 illustrates a total of 48 slots composed of six FDMA slots (designated FDMA #1 to FDMA #6, respectively), each of which divided into 8 TDMA slots (amounting together to 48 slots). The slots are allocated to the various user nodes (designated as A/C XXX, where XXX is the identification of the given user node). Thus, for example A/C#115 (701) is allocated with a one slot resource (FDMA #4 and TDMA #4). A/C#121 (702), in turn, is allocated with two slots (FDMA #6 and TDMA #1,2), whereas A/C#123 (703) is allocated with three slots (FDMA #4 and TDMA #1,2,3), and so forth. The invention is, of course, not bound by these particular examples. As specified, the resource allocation map may be broadcasted or transmitted, e.g. in partial chunks, or to one or more users (intuitively-user node #X, your allocated resources are Y), etc.

Reverting now to FIG. 3 and specially to inquiry 319, and in case of “No” (322) indicative of the fact that there are no available resources for allocation, the resource allocation map may be updated to indicate new allocated resources to the at least one requesting user node and the transmitting user nodes, while reducing resources to at least one affected transmitting node of the transmitting nodes, based on at least its degraded user node's QOS grade compared to the user's QOS grades of the other non-affected transmitting nodes.

Thus, in accordance with certain embodiments, considering that there are no resources for allocation, the hub node may reduce resources (possibly, in certain embodiments, the reduction means reduce to 0 of allocated resources) from already transmitting node or nodes (being an example of affected transmitting nodes) and avail the resource(s) for the requesting user (s) nodes. In accordance with certain embodiments, a priority in resource allocation is given to nodes having higher user node's QOS grade over those which have a lower user's QOS grade. Thus, by this example, there may be non-affected transmitting node(s) (in the sense that its allocated resources for transmission are not affected—assuming that it still has payload to transmit) if, for example, their QOS grade is higher than those of the affected transmitting node(s)). Note that throughout the description there are given various examples of allocating resources to users, all being non-limiting examples of how to apply the specified priority in allocation criterion. Note also that the priority in allocating resources, while exemplified for clarity with respect to only the QOS grade, may be based also on other parameters.

Thus, for example the criterion for reducing the allocated resources for the transmitting users starts with the transmitting node having the lowest user's QOS grade. In this context, and as may be recalled, a QOS threshold value has been calculated by the hub node (see stage 305) based on the user's QOS values of the transmitting nodes, e.g. by applying the median function. Considering the median function, typically, the QOS threshold value is higher than the at least one of the user's QOS values of the transmitting nodes, whereas the user node's QOS grade of any of the requesting nodes is higher than the threshold (see stages 311 and 315). It is accordingly appreciated that in accordance with certain embodiments, any of the requesting nodes has a higher priority user node's QOS grade over the transmitting node(s) having a user node's QOS grade that drops below the threshold, and, a fortiori, over the transmitting node with the lowest user's QOS grade. Note the latter condition is merely an example, and is by no means binding. The criterion may prescribe, for instance, in case of one requesting node:
(i) Reduce by x % (or, if not possible, to reduce by x % then reduce to 0) the allocated resource of the transmitting node having the lowest user node's QOS grade and assign it to the requesting node;

In case of n>1 requesting nodes:
(ii) Reduce by x % (or if not possible to reduce by x % then reduce to 0) the allocated resource of the transmitting node having the lowest (minimal) user node's QOS grade and assign it to a first requesting node; repeat the procedure for the other n−1 transmitting nodes having next the lowest QOS values (excluding the specified minimum user's QOS value), and so forth, until all requesting nodes are allocated with resources (as reflected in the allocation map).

Turning now to the specific example of FIG. 3, as shown in stage 323, an inquiry may be made as to whether the resource of the transmitting node, with, say, the lowest—user node's QOS grade, can be divided (namely, by this example, reduced by 50%), if “no” 327′ then the entire resource (or, as specified above, with reference to certain embodiments, except for certain spare resources) may be allocated to the requesting user node (i.e. the allocated resource for the transmission node is reduced to “0” 328′) and if “yes” 324, then the resource may be divided (say, by half), and the other half (in this example) may be allocated to the requesting user node 325. In case there is more than one requesting node, the specified sequence may be repeated with respect to the transmitting node having the next lowest user node's QOS grade (i.e. second lowest), and then, if applicable, the third lowest user node's QOS grade, and so forth.

Note that, although not shown in the FIGS., in accordance with certain embodiments, the hub node may apply a bias policy. For instance, in accordance with an example of the bias policy, consider a scenario of a commander and soldiers, where the transmitting commander user node has a privileged class compared to transmission of the user soldiers' nodes having non-privileged class. Thus, even if the payload data of the soldier user nodes have a higher QOS grade compared to those of the transmitting commander user node, the resources of the latter will be retained intact (while reducing resources of the transmitting soldier user nodes), because of the privileged class of this user. The invention is, of course not bound by the specified bias policy, which is provided for clarity of explanation only.

The bias policy may be applied mutatis mutandis also with respect to requesting user nodes. For instance, in accordance with a certain embodiment, a privileged class user node may invoke an access request, even if its user node's QOS grade does not exceed the QOS threshold value (say exceeding only 50% of the threshold). These are, of course, only non-limiting examples of a bias policy that may applied.

Reverting now to FIG. 3, and as discussed above, the newly allocated resources to the requesting users, as well as those of the transmitting users, are updated in a resource allocation map 326, and the updated resource allocation map is then broadcast (327) over the hub transmission link.

Note that FIG. 4 illustrates the corresponding stages 419-427 executed at the hub node end.

Note that the specified steps 319 to 327 (or 419-427) may be executed in module 25 (resource allocation module) of FIG. 2A under the supervision of control module 23, and the data may be transmitted through I/O 22.

Note that the description with reference to stages 319 to 327 illustrates a few non-limiting examples of the stage of updating the resource allocation map to indicate new allocated resources for the transmitting user nodes and the at least one requesting user node, constituting together updated transmitting user nodes while giving priority in allocation to nodes having higher user node's QOS value over nodes having lower user's QOS value, as well as broadcasting said updated resource allocation map through said hub transmission link.

Turning now to the user node, in stage 328 the user node may receive the allocation map and identify its newly allocated resource.

In response to receipt of the resource allocation map, the user node may transmit, through the resource allocated to the user node in said map (329), selected payload data of said plurality of payload data, along with said user node's QOS value (and possibly other control data of the control portion associated with the payload data), until a transmit stop criterion is met. In accordance with certain embodiments, the stop criterion may be e.g. all queued payload data was transmitted, or a halt command is received from the hub node, or a newly received resource allocation map is received with no allocation to the user, or there is a criterion which originated at the user's node to transmit only selected payload data, or transmission is halted for a given reason. These specified stop criteria examples are not binding.

Note that the specified stages performed by the user node (328-329) are also illustrated in corresponding stages (528-529) of the sequence of operations performed by the user node, as depicted in FIG. 5.

Note that the specified steps 328 to 329 (or 528-529) may be executed in module 250 (payload transmission module) of FIG. 2B under the supervision of control module 23 and the data may be transmitted/received through I/O 22.

In cases where no resources are allocated to the user node (in the newly received map), the latter may halt the transmission. In accordance with certain embodiments, in cases where an allocated resource is not sufficient for transmission of all queued payload data, there is a need to prioritize the payload for transmission through the allocated resource e.g. by selecting payload data according to a payload data transmission criterion that depends on at least their QOS value. For instance, a commercially available QOS queuing mechanism may be used, such as CBWFQ—Classed Based Weighted Fair Queuing, which is a QOS based ordering, which takes care also for the “weak”, to prevent starvation. The invention is, of course, not bound by this example.

As specified above, the user node may (periodically) calculate its own user node's QOS grade (considering that the contents of the queue are changed due to the transmissions).

Before moving on to steps 331 and onwards, attention is reverted to stage 309, in case of “NO”, (namely the user node is transmitting), then obviously the transmitting node does not need to request a resource (as it already has done so). Therefore, the user node will transmit its own payload, but will also transmit its own updated calculated Queue Grade (330) in order that the HUB will be able to recalculate the network threshold value. It is thus appreciated that, as the user node transmits payload data that are extracted from the payload queue (or queues), its QOS grade changes, considering that there is a change in the queued packets (some have been transmitted, and possibly others added), and, consequently, (and as discussed in detail above), this may affect the so-calculated QOS grade.

Moving on, and as further outlined in stages 331 to 334, in cases where the user node has completed transmission, the hub node may free the user node's resources for future allocation to other requesting user node(s), and may recalculate the resource allocation of the transmitting users ‘on-the-fly’, according to the QOS grades of the currently transmitting user nodes.

Note that in accordance with certain embodiments, the transmission of user generated payload data complies with an IP protocol, and the payload data are IP packets.

Thus, in certain embodiments, at least the following advantages are obtained:
Allowing transparent IP communication links to a large number of users, (even greater than the amount of available resources) according to their QOS grade.
Support congested network—since the network resources are not private/reserved, they are shared between all users according to their QOS grade.
Network High efficiency for a congested network (Busy Network/BZNET).
Allowing transparent IP communications under strict EEP (Electromagnetic Emission Policy)—idle users do not require to maintain an active link, since the resources do not belong to them in the first place (in comparison to other wireless networks, in which the resource is private and available, even if the user node is idle).
The wireless resources are divided between the users' nodes according to a common QOS grades criterion.

It is noted that the teachings of the presently disclosed subject matter are not bound by the hub node system and/or the user node system, and modules described with reference to FIGS. 2A or 2B. Equivalent and/or modified functionality can be consolidated or divided in another manner and can be implemented in any appropriate combination of software with firmware and/or hardware, and executed on a suitable device. The hub node system can be a standalone network entity, or integrated, fully or partly, with other network entities. Those skilled in the art will also readily appreciate that the data repositories can be consolidated or divided in other manner; databases can be shared with other systems, or be provided by other systems, including third party equipment. The same holds true of any of the user node systems.

It is further noted that the teachings of the presently disclosed subject matter are not bound by mapping of the specified computational stages (in any of FIGS. 3 to 5) to distinct modules described with reference to FIGS. 2A or 2B. Other modules and/or different mappings may apply.

For purpose of illustration only, the description, as provided herewith, applies to satellite communication. Those skilled in the art will readily appreciate that the teachings of the presently disclosed subject matter are not limited to only satellite communication.

It is noted that the teachings of the presently disclosed subject matter are not bound by the flow chart illustrated in FIG. 3 or 4 or 5, and that the illustrated operations can occur out of the illustrated order. It is also noted that whilst the flow chart is described with reference to elements of system (20) and or 200 of FIGS. 2A and 2B, this is by no means binding, and the operations can be performed by elements other than those described herein. Note also that the invention is not bound by the specified computational stages described with reference to any of FIGS. 3, 4 or 5, and, accordingly, in accordance with certain embodiments, steps may be deleted and/or combined with others, and or executed in a different order and/or modified and/or others may be added in addition to or instead of those illustrated in the drawings.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A computerized hub node for generating a dynamic resource allocation map, informative of allocation of resources to a plurality of user nodes, in a wide bandwidth shared wireless link, the hub node comprising a processor and memory circuitry (PMC) configured to perform repeatedly, including:
calculating a QOS threshold value based on user's QOS grades of transmitting user nodes, and transmitting said QOS threshold;
receiving at least one resource allocation request originating by corresponding at least one requesting user node including identifying said at least one user node;
updating the resource allocation map to indicate new allocated resources for the transmitting user nodes and the at least one requesting user nodes, constituting, together, updated transmitting user nodes, while giving priority in allocation of resources to nodes having higher user node's QOS grade over nodes having lower user's QOS grade; and
transmitting said updated resource allocation map to at least the requesting user nodes through a hub transmission link;
thereby facilitating transmission of user payloads over the wide bandwidth shared wireless link, according to said updated resource allocation map.

2. The computerized hub node according to claim 1, wherein said resource allocation request is generated by said requesting user nodes in response to meeting a QOS criterion that depends on said QOS threshold.

3. The computerized hub node of claim 1, wherein said updating the resource allocation map while giving priority in allocation to nodes having higher user node's QOS grade over nodes having lower user's QOS value, includes: in case there are not sufficient resources to meet the request of said at least one requesting user node, updating the resource allocation map to indicate allocated resources to the at least one requesting user node and reducing resources to at least one affected transmitting user node of said transmitting user nodes, based on at least its degraded user node's QOS grade compared to the user's QOS grades of at least one non affected transmitting node of said transmitting nodes.

4. The computerized hub node of claim 3, wherein said reducing includes reducing the resources, starting from the lowest user node's QOS grade of an affected transmitting node, and repeating, if required, for the next lowest user node's QOS grades of another affected transmitting node, until the requests of all requesting user nodes are met.

5. The computerized hub node of claim 4, wherein said reducing includes selectively reducing the allocated resources to an affected transmitting node by X % (X≤100).

6. The computerized hub node of claim 1, wherein said updating the resource allocation map while giving priority in allocation to nodes having higher user node's QOS grade over nodes having lower user's QOS grade, includes: in case the link is not fully occupied, allocate available resources to the requesting at least one node.

7. The computerized hub node according to claim 1, wherein said wide bandwidth shared wireless link is an RF channel.

8. The computerized hub node according to claim 1, wherein the QOS threshold value is based on the median function of the user's QOS grades.

9. The computerized hub node according to claim 2, wherein, in case said shared wireless link is not fully occupied, setting said QOS threshold to a value that allows any requesting node to meet said QOS criterion.

10. The computerized hub node according to claim 1, wherein the transmission of said QOS threshold is performed as a broadcast over a hub transmission link.

11. The computerized hub node according to claim 1, wherein the receiving of said at least one resource allocation request is performed through a narrow bandwidth access request link.

12. The computerized hub node according to claim 1, wherein the transmission of user payload data complies with an IP protocol, and wherein the payload data are IP packets.

13. A computerized user node for transmission of user generated payloads over a wide bandwidth shared wireless link, the user node comprising a processor and memory circuitry (PMC) configured to perform repeatedly, including:
obtaining, from at least one host application associated with the user node, a plurality of payload data associated control that includes Quality of Service (QOS) value and calculating a user node's QOS grade according to at least said QOS values;
receiving from a hub node a QOS threshold value;
in case of meeting a QOS criterion, transmitting, through a narrow bandwidth access request link, a resource allocation request, said QOS criterion that depends on said QOS threshold and said QOS grade;
responsive to said request, receive from the hub node a dynamic resource allocation map, informative of allocation of resources in a wide bandwidth shared wireless link to a plurality of user nodes;
transmitting, through the resource allocated to the user node in said map, selected payload data of said plurality of payload data along with said user's QOS value, until a transmit stop criterion is met;
said payload data being selected according to a payload data transmission criterion that depends on at least their QOS value.

14. The computerized user node of claim 13, wherein the wide bandwidth shared wireless link is an RF channel.

15. The computerized user node of claim 13, wherein said calculating a user node's QOS grade according to said QOS values is based on weighted average of said QOS values.

16. The computerized user node of claim 15, wherein said plurality of payload data are accumulated in at least one queue according to their QOS value, and wherein said weighted average takes into account the queue's length.

17. The computerized user node of claim 15, wherein said QOS grade complies with the following equation: Grade=Σᵢ₌₁ⁿ(length_{Qi}·weight_{TOS}_{ᵢ})
where length_{Qi} is the number of total IP packets in queueᵢ, weight_{TOS}_{ᵢ}, is TOS value of queueᵢ packets, and n is the number of queues.

18. The computerized user node of claim 13, said threshold being received from the hub node over a hub transmission link.

19. The computerized user node of claim 13, wherein said dynamic resource allocation map is received from the hub node over a transmission link.

20. The computerized user node of claim 13, wherein said transmit stop criterion is met in case at least one of the following conditions is met: (i) all obtained payload data are transmitted, (ii) a halt command is received from the hub or (iii) an updated dynamic resource allocation map is received where no resources are allocated to the user node.

21. The computerized user node of claim 13, wherein said payload data transmission criterion that depends on at least their QOS value includes applying a QOS queuing mechanism that includes CBWFQ—a Class Based Weighted Fair Queuing technique.

22. The computer user node according to claim 13, further comprising: in case data informative of the resource allocation map is received from the hub while transmitting, wherein said map includes updated resource allocating, update said selected payload data to fit the newly allocated resource.

23. The computerized user node according to claim 13, wherein the transmission of user payload data complies with an IP protocol, and wherein the payload data are IP packets.

24. The computerized user node according to claim 13, wherein said payload data are generated or received by at least one host application associated with said user node.

25. A method for generating a dynamic resource allocation map, informative of allocation of resources to a plurality of user nodes in a wide bandwidth shared wireless link; the method comprising performing repeatedly by a processor and memory circuitry (PMC):
calculating a QOS threshold value based on a user's QOS grades of transmitting user nodes, and broadcasting said QOS threshold;
receiving at least one resource allocation request originating by corresponding at least one requesting user node including identifying said at least one user node;
updating the resource allocation map to indicate new allocated resources for the transmitting user nodes and the at least one requesting user node, constituting together updated transmitting user nodes while giving priority in allocation of resources to nodes having higher user node's QOS grade, over nodes having lower user's QOS grade; and
transmitting said updated resource allocation map to at least the requesting user nodes through a hub transmission link;
thereby facilitating transmission of user generated payloads over the wide bandwidth shared wireless link, according to said updated resource allocation map.

26. A method for transmission of user payloads over a wide bandwidth shared wireless link, the method comprising performing repeatedly, by a processor and memory circuitry (PMC):
obtaining from at least one host application associated with a user node, a plurality of payload data associated control that includes Quality of Service (QOS) value and calculating a user node's QOS grade according to at least said QOS values;
receiving from a hub node a QOS threshold value;
in case of meeting a QOS criterion, transmitting, through a narrow bandwidth access request link, a resource allocation request, said QOS criterion that depends on said QOS threshold and said QOS grade;
receiving from the hub node, responsive to said request, a dynamic resource allocation map, informative of allocation of resources in a wide bandwidth shared wireless link to a plurality of user nodes; and
transmitting, through the resource allocated to the user node in said map, selected payload data of said plurality of payload data along with said user's QOS value, until a transmit stop criterion is met;
said payload data are selected according to a payload data transmission criterion that depends on at least their QOS value.

27. A non-transitory computer readable storage medium tangibly embodying a program of instructions that, when executed by a computer, cause the computer to perform a method of generating a dynamic resource allocation map, informative of allocation of resources to a plurality of user nodes, in a wide bandwidth shared wireless link, according to claim 25.

28. A non-transitory computer readable storage medium tangibly embodying a program of instructions that, when executed by a computer, cause the computer to perform a method of transmission of user generated payloads over the wide bandwidth shared wireless link, according to claim 26.
